(19) United States
(12) Patent Application Publication
(10) Pub. No.: US 2007/0103892 A1
(43) Pub. Date: May 10, 2007

(54) Toolbox with lighted handle

(75) Inventors: Renfred K. McDaniel, Clayton, NC (US); Robert B. Grubbs, Fuquay-Varina, NC (US); Brian D. Westbrook, Morrisville, NC (US); John F. Serraino, Cary, NC (US); Mark W. Pardue, Wilson, NC (US)

Correspondence Address: COATS & BENNETT, PLLC, 1400 Crescent Green, Suite 300, Cary, NC, 27518, US

(73) Assignee: Cooper Brands, Inc.

(21) Appl. No.: 11/269,113

(22) Filed: Nov. 8, 2005

(51) Int. Cl. B25B 23/18; F21V 33/00; A45C 15/06; B65D 85/28

(52) U.S. Cl. 362/119; 362/154; 362/156; 206/373

(57) ABSTRACT

A toolbox has a toolbox body with a tool storage compartment; a handle connected to the body; the handle having a light source, at least one battery, and a switch; the switch selectively energizing the light source by electrically connecting the battery and the light source. The light source may be first and second LEDs disposed on opposite sides of the handle's central grip area. The handle may be substantially longitudinally rigid and rotatably moveable relative to the storage compartment through an arc. The handle may be connected to the toolbox body by releasable mechanical connectors, such as by carabineers engaging opposing ends of the handle.

### BACKGROUND OF THE INVENTION

The present invention is directed generally to portable toolboxes, and more particularly to a portable toolbox with a handle having a built-in light.

Portable toolboxes provide a convenient means to store hand tools and small power tools when not in use. Existing toolboxes are available in a wide variety of shapes, but typically take the form of a three-dimensional rectangular box with a hinged lid or cover. Such toolboxes are typically constructed of metal or other sturdy material.

Portable toolboxes are frequently used at construction sites where lighting conditions are less than ideal. Due to the poor lighting conditions, it is sometimes difficult for a worker to identify the desired tool stored in the toolbox's main storage compartment. Of course, if the worker has a separate flashlight, the worker can use the flashlight to help illuminate the storage compartment, and thereby find the tool. However, use of a separate flashlight typically occupies one of the worker's hands, which is not always convenient. Also, having a separate flashlight requires the worker to keep track of and store the flashlight, which frequently leads to the flashlight becoming misplaced or lost.

Thus, there remains a need for alternative portable toolbox designs, advantageously designs that incorporate a convenient light source for use in illuminating the toolbox's main storage compartment.

### SUMMARY OF THE INVENTION

In one embodiment, the present invention provides a toolbox comprising: a toolbox body having a tool storage compartment; a handle connected to the body; the handle having a light source, at least one battery, and a switch; the switch selectively energizing the light source by electrically connecting the at least one battery and the light source. At least one releasable mechanical connector may releasably connect the handle to the body. The at least one releasable mechanical fastener may comprise at least first and second carabineers disposed on opposing ends of the handle. The light source may comprise at least one LED, such as first and second LEDs. The handle may have a central grip area, and wherein the first and second LEDs are disposed on opposite sides of the central grip area outboard of the central grip area. The switch may be disposed in the central grip area, and the central grip area may have a removable cover providing access to the battery. The handle may be substantially longitudinally rigid. The handle may be rotatably moveable relative to the body through an arc; with the light source disposed so as to direct light into the tool storage compartment throughout the arc when the storage compartment is open and the light source is energized. The toolbox body may be metallic or formed of fabric. The toolbox exterior may be a first color; with the tool storage compartment having walls of a second, lighter color than the first color. The storage compartment may comprise first and second substantially rigid end walls and/or may be substantially rectangular in cross-section. There may also be a shoulder strap for carrying the toolbox.

In another embodiment, the present invention provides a toolbox comprising: a toolbox body having a tool storage compartment; a carrying and illuminating means for carrying the toolbox body and selectively illuminating the storage compartment; and first and second mechanical connectors releasably connecting the carrying and illuminating means to the toolbox body. The toolbox body may have a fabric exterior of a first color; with the tool storage compartment having walls of a second, lighter color than the first color. The storage compartment may be substantially rectangular in cross-section, have first and second substantially rigid end walls, with flexible sidewalls disposed between the first and second end walls.

In another embodiment, a method of assembling a toolbox comprises: providing a toolbox body having a tool storage compartment defined therein; providing a handle having a light source, at least one battery, and a switch; connecting the handle to the body; and selectively energizing the light source via the switch by electrically connecting the battery and the light source. The selectively energizing the light source advantageously comprises shining light from the light source into the tool storage compartment. The light source may be one, two, or more LEDs, and the toolbox may have other features as described above, such as a releasable handle.

### BRIEF DESCRIPTION OF THE DRAWINGS

FIG. 1 shows one embodiment of a toolbox constructed in accordance with the present invention.

FIG. 2 shows the toolbox of FIG. 1 with a main storage compartment open and with the shoulder strap removed.

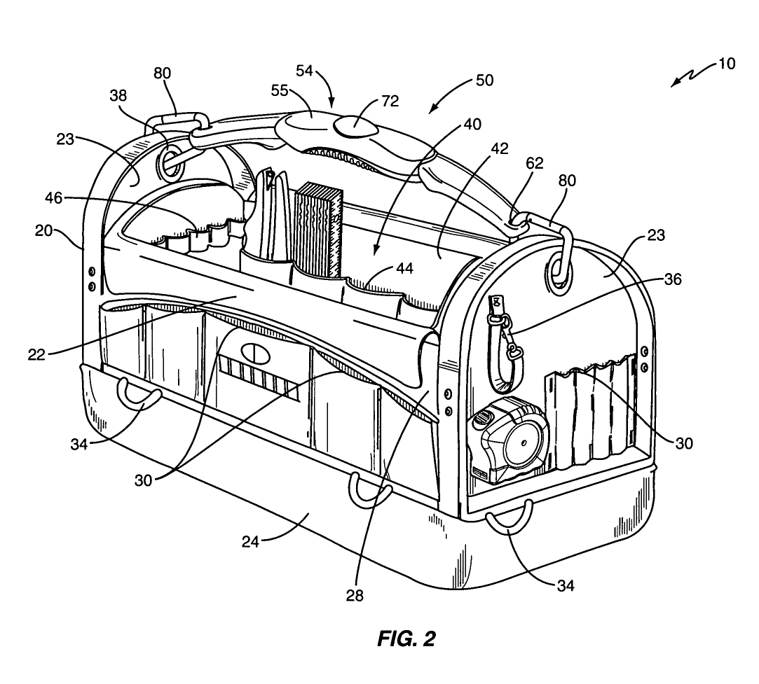

FIG. 3 shows the handle of the toolbox of FIG. 2 with the mechanical connectors attached thereto in the form of carabineers.

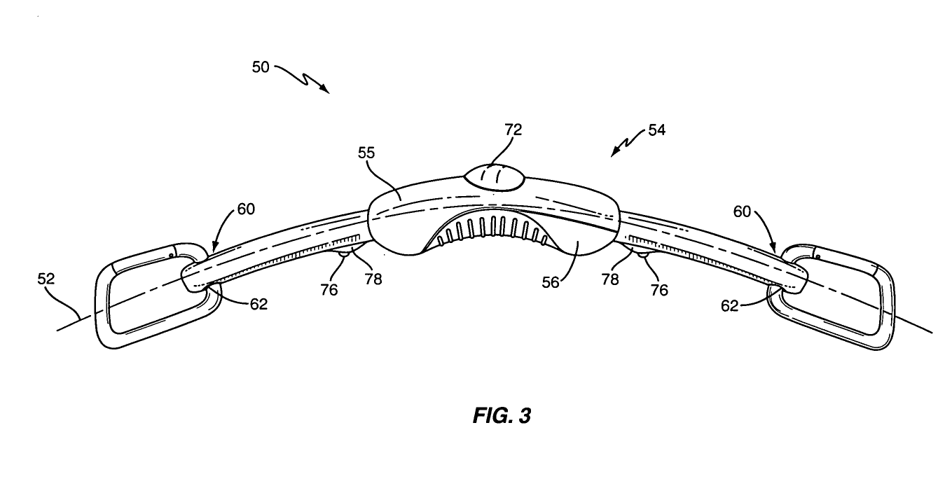

FIG. 4 shows further detail of the handle of FIG. 3.

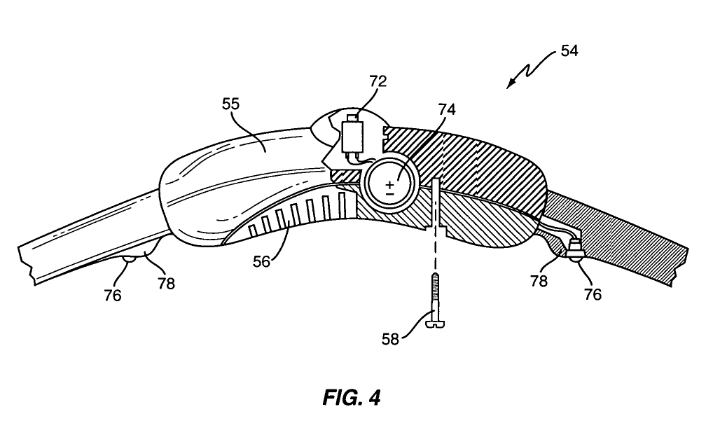

### DETAILED DESCRIPTION OF THE INVENTION

The toolbox 10 of the present invention includes a handle 50 with a built-in switch-controlled light source 76. The presence of the light source 76 in the handle 50 allows the main storage compartment 40 of the toolbox 10 to be selectively illuminated by the handle 50, thereby freeing the worker's hands from the need to hold a separate flashlight.

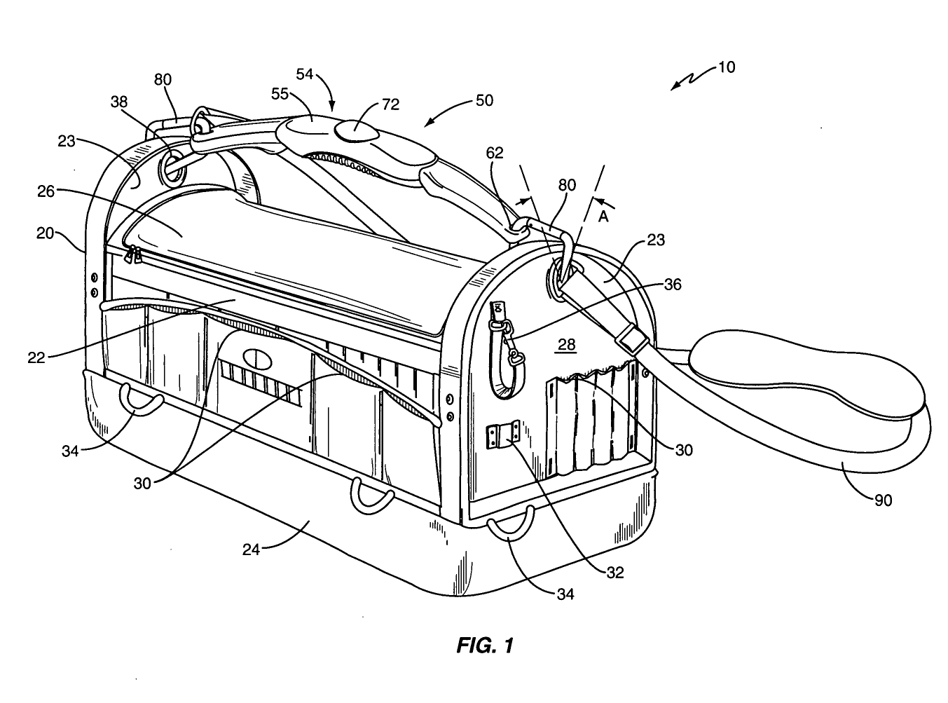

A toolbox according to one embodiment of the present invention is shown in FIG. 1 and generally designated 10. The toolbox 10 includes a toolbox body 20, a handle 50, and mechanical connectors 80 connecting the handle 50 to the main toolbox body. The toolbox body 20 has peripheral walls forming a generally rectangular shape, with respective sidewalls 22, endwalls 23, and a bottom 24. The toolbox body 20 may be metallic, but a fabric based body is believed to be advantageous. If formed of fabric, it may be advantageous to have a reinforcing elements (not shown) embedded in the fabric. For example, the two longitudinal endwalls 23 and bottom 24 may have substantially full-size reinforcing panels embedded therein, with the lateral sidewalls 22 having limited size reinforcing ribs embedded therein. The reinforcing elements may be formed of any suitable rigid material, such as plastic, wood, or other rigid material. It should be noted that the limited size reinforcing ribs in the sidewalls 22 may be advantageously located proximate the upper edge of the sidewalls 22, leaving the lower portions of the sidewalls 22 relatively flexible. This arrangement allows the toolbox to be “soft-sided,” which is desirable to some consumers. For further discussion on embedded reinforcing elements in portable toolboxes, see U.S. Pat. No. 6,823,992, which is incorporated herein by reference.

The sidewalls 22, endwalls 23, and other portions of the exterior 28 of the toolbox body 20, may have various pockets 30 and the like defined thereon for storing tools and other work materials. In addition, the endwalls 23 and/or sidewalls 22 may include a clip 32 for attaching a conventional tape measure, various tethered clips 36, and other tool attachment means. Suitable reinforced grommets 38 are disposed on upper portions of the longitudinal endwalls 23, for connecting the handle 50 as discussed further below. The bottom section 24 of the toolbox body 20 may be reinforced and/or padded, as the bottom section 24 of the toolbox body 20 is expected to be subjected to significant loading and wear. In addition, there may be a plurality of metal “D” rings 34, or similar structures, disposed about the periphery of the toolbox body 20, for attaching keys, straps, and other items. And, if desired, the exterior 28 of the toolbox body 20 may have suitable areas defined thereon for supplier logos, instructional information, or the like. Further, in some embodiments, the exterior 28 of the toolbox 10 may include reflectors or other means to highlight the toolbox 10 in poorly lit environments. For example, some form of reflective thread may be used with a fabric-based exterior 28 to highlight the toolbox 10.

The toolbox body 20 has a centrally located main tool storage compartment 40 that is accessed from above. The storage compartment 40 is defined by interior walls 42 of the toolbox body 20, and is advantageously generally rectangular in top view. The interior walls 42 forming the storage compartment 40 may advantageously have suitable tool storage pockets 44 and retaining straps 46 attached thereto. In addition, the tool storage compartment's walls 42 may advantageously be in a light color, particularly a lighter color than the exterior of the toolbox body 20, so as to increase visibility in the tool storage compartment 40. In some embodiments, the tool storage compartment 40 may be closed via a top flap 26. The flap 26 may be secured in place using any conventional means, such as snaps, zippers, and the like.

The handle 50 provides a convenient means for carrying the toolbox 10. The handle 50 is advantageously elongate, extending along a longitudinal axis 52 that may be straight or curved. It is believed that some curve in the handle 50, either a continuous bending curve or in a series of bends, is more advantageous than a purely straight handle configuration. The handle 50 is advantageously substantially rigid along its longitudinal axis 52, so as to provide a mechanical reinforcement to keep the longitudinal endwalls 23 of the toolbox body 20 from collapsing inward when the toolbox 10 is being carried by the handle 50. The handle 50 includes a central area 54 and respective end portions 60. The central area 54 includes a grip structure 55, and may therefore be referred to herein as the central grip area 54. The grip structure 55 provides an expanded area contoured and designed to be gripped by a worker. For example, the grip structure 55 may be covered in an elastomeric material, with the underside of the grip structure 55 having suitable ridges or other grip enhancing surface features. The handle's end portions 60 include suitable holes 62 for mating with the mechanical connectors 80 that connect the handle 50 to the toolbox body 20. These holes 62 are advantageously suitably reinforced, and are sized to provide a sliding fit with the connectors 80, as discussed further below.

The handle 50 also includes a built-in light source 76 and associated electronics 72, 74. The light source 76 advantageously takes the form of two high intensity light emitting diodes (LEDs), one disposed on each side of the central grip area 54. That is, the LEDs 76 are advantageously located slightly outboard of the area 54 typically gripped by a worker when carrying the toolbox 10 via the handle 50. The LEDs 76 are oriented to shine their light downward, directly into the main storage compartment 40. The LEDs 76 may, if desired, be disposed in protective bump-like 78 projections on the underside of the handle 50, although this is not required.

The LEDs 76 are selectively powered via battery 74 and switch 72, which are housed in the central grip area 54 of the handle 50. The battery 74 typically takes the form of a small disc-shaped battery of the type typically found in watches, but other types of batteries may be used, and there may be more than one battery 74 if desired. The battery 74 is advantageously replaceable. In order to facilitate this, the central grip area 54 may include a battery access cover 56 on its lower side. The battery access cover 56 may be secured to the remainder of the handle 50 via snaps, screws 58, or the like. Removal of the battery access cover 56 allows the user to access the battery 74 for inspection or replacement. The switch 72 is advantageously disposed on an upper portion of the central grip area 54 and oriented to point upward, generally away from the main storage compartment 40. The switch 72 may be of any type known in the switch art. For example, the switch 72 may be of the momentary type (requiring constant pressure activate) or may be of the push/release type. The switch 72 controls the electrical power supply to the LEDs 76 from the battery 74, and thus the energization station of the LEDs 76. When closed, the switch 72 closes the electrical circuit from the battery 74 to the LEDs 76. Accordingly, the user may selectively control the electrical connection to the LEDs 76, and thus the on/off state of the light source 76, via the switch 72.

The handle 50 is connected to the main toolbox body 20 via mechanical connectors 80. The mechanical connectors 80 may take any form known in the art, such as rivets, snap connections, or the like. However, in some preferred embodiments, these mechanical connectors 80 take the form of carabineers. The carabineers 80 extend through corresponding holes 62 in the handle end portions 60 and the grommets 38 on the main toolbox body 20. The use of carabineers 80 allows the handle 50 to be readily removable, but provides a mechanical link between the handle 50 and the main toolbox body 20 that resists longitudinal compressive loads. To this end, the holes 62 on handle ends 60 are advantageously sized to provide a sliding fit with the carabineers 80. This type of mechanical connection allows the handle 50 to rotate about a theoretical line connecting the grommets 38 on the main toolbox body 20 through a limited arc A. This type of limited movement is believed to provide improved access to the main storage compartment 40, while limiting longitudinal movement of the handle 50 relative to the toolbox body 20. Further, the carabineers 80 provide a convenient means to clip on other items, such as key chains and the like. Advantageously, a carabineer 80 is used on each end 60 of the handle 50, but some less preferred embodiments may only use only one carabineer 80 on one end 60 of the handle 50; or, as pointed out above, other mechanical connector means (releasable or otherwise) may be employed.

The toolbox 10 may be used to carry tools by placing the tools in the main storage compartment 40, the optional pockets 30, etc. When used in a poorly lit environment, the user may turn on the LEDs 76 via switch 72. The LEDs 76 then shine light into the main storage compartment 40. This light may directly shine on the tools in the main storage compartment 40, and may be reflected onto the tools from the light-colored sidewalls 42 of the main storage compartment 40. Because the LEDs 76 are built into the handle 50, the LEDs 76 shine light into the main storage compartment 40 even when the handle 50 is rotated from one position to another through arc A. Further, due to the location of the LEDs 76 relative to the main gripping area 54 in some embodiments, the 76 LEDs may shine their light into the main storage compartment 40 even when the worker is supporting the toolbox 10 via handle 50. In addition, the handle 50 may, in come embodiments, be removed from the main toolbox body 20 so as to provide a light source 76 for illuminating a nearby workspace, and then reattached for transport.

The discussion above has assumed that the light source 76 takes the form of two LEDs. However, the light source 76 may, in some embodiments, be only a single LED 76, include more than two LEDs (such as four or more), and/or may be formed of conventional incandescent light bulbs, electroluminescent panels, or other types of visible light emitting light sources known in the art.

While the handle 50 provides a convenient means for carrying the toolbox 10 and illuminating the storage compartment 40, the toolbox 10 may include a supplemental shoulder strap 90 for carrying the toolbox 10 on the worker's shoulder, if desired. Such a shoulder strap 90 may connect to the lower portion of the main toolbox body 20 via suitable “D” ring 34 connections or the like, and should advantageously be readily removable.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. A toolbox, comprising:
a toolbox body having a tool storage compartment;
a handle connected to said body; and
said handle having a light source, at least one battery, and a switch; said switch selectively energizing said light source by electrically connecting said at least one battery and said light source.

2. The toolbox of claim 1 further comprising at least one releasable mechanical connector releasably connecting said handle to said body.

3. The toolbox of claim 2 wherein said at least one releasable mechanical fastener comprises at least one carabineer.

4. The toolbox of claim 3 wherein said at least one releasable mechanical fastener comprises at least first and second carabineers disposed on opposing ends of said handle.

5. The toolbox of claim 1 wherein said light source comprises at least one LED.

6. The toolbox of claim 5 wherein said light source comprises at least first and second LEDs.

7. The toolbox of claim 6 wherein said handle has a central grip area, and wherein said first and second LEDs are disposed on opposite sides of said central grip area outboard of said central grip area.

8. The toolbox of claim 7 wherein said switch is disposed in said central grip area and said central grip area comprises a removable cover providing access to said at least one battery.

9. The toolbox of claim 1 wherein said handle extends along a longitudinal axis and is substantially longitudinally rigid.

10. The toolbox of claim 9 wherein said handle is longitudinally curved.

11. The toolbox of claim 1 wherein said handle is rotatably moveable relative to said body through an arc; and wherein said light source is disposed so as to direct light into said tool storage compartment throughout said arc when said storage compartment is open and said light source is energized.

12. The toolbox of claim 1 wherein said toolbox body is metallic.

13. The toolbox of claim 1 wherein said toolbox body has a fabric exterior of a first color; and wherein said tool storage compartment has walls of a second, lighter color than said first color.

14. The toolbox of claim 1 wherein said storage compartment is substantially rectangular in cross-section.

15. The toolbox of claim 14 wherein said storage compartment comprises first and second substantially rigid end walls.

16. The toolbox of claim 15 wherein said storage compartment comprises flexible sidewalls disposed between said first and second end walls.

17. The toolbox of claim 1 further comprising a shoulder strap for carrying said toolbox.

18. A toolbox, comprising:
a toolbox body having a tool storage compartment and a fabric exterior of a first color; said storage compartment having walls of a second, lighter color than said first color;
a substantially longitudinally rigid handle having a central grip area, a light source, at least one battery, and a switch;
at least first and second carabineers releasably connecting said handle to said body, said first and second carabineers disposed on opposing ends of said handle;
said light source comprising first and second LEDs disposed on opposite sides of said central grip area outboard of said central grip area;
said switch selectively energizing said light source by electrically connecting said at least one battery and said light source; and
wherein said handle is rotatably moveable relative to said body through an arc; and wherein said LEDs are disposed so as to direct light into said storage compartment throughout said arc when said storage compartment is open and said light source is energized.

19. The toolbox of claim 18 wherein said switch is disposed in said central grip area and said central grip area comprises a removable cover providing access to said at least one battery.

20. A toolbox, comprising:
a toolbox body having a tool storage compartment;
a carrying and illuminating means for carrying said toolbox body and selectively illuminating said storage compartment; and
first and second mechanical connectors releasably connecting said carrying and illuminating means to said toolbox body.

21. The toolbox of claim 20 wherein said toolbox body has a fabric exterior of a first color; and wherein said tool storage compartment has walls of a second, lighter color than said first color.

22. The toolbox of claim 20 wherein said storage compartment is substantially rectangular in cross-section, comprises first and second substantially rigid end walls, and comprises flexible sidewalls disposed between said first and second end walls.

23. A method of assembling a toolbox, comprising:
providing a toolbox body having a tool storage compartment defined therein;
providing a substantially longitudinally rigid handle having a light source, at least one battery, and a switch;
connecting said handle to said body; and
selectively energizing said light source via said switch by electrically connecting said at least one battery and said light source to shine light from said light source into said tool storage compartment.

24. The method of claim 23 wherein said light source comprises at least first and second LEDs and wherein said selectively energizing said light source to shine light from said light source into said tool storage comprises selectively energizing said light source to directly shine light from said first and second LEDs into said tool storage compartment.

25. The method of claim 24 wherein said handle further comprises a central grip area and wherein said first and second LEDs are disposed on opposing sides of said central grip area and outboard thereof.

26. The method of claim 23 wherein said connecting said handle to said body comprises releasably connecting said handle to said body.
